(19) United States
(12) Patent Application Publication
(10) Pub. No.: US 2003/0025644 A1
(43) Pub. Date: Feb. 6, 2003

(54) Multibeam antenna

(75) Inventor: Thierry Judasz, Ramonville (FR)

Correspondence Address: SUGHRUE MION, PLLC, 2100 Pennsylvania Avenue, NW, Washington, DC, 20037-3213, US

(73) Assignee: ALCATEL

(21) Appl. No.: 10/211,306

(22) Filed: Aug. 5, 2002

(30) Foreign Application Priority Data
Aug. 6, 2001 (EP) 01 402 114.1

(51) Int. Cl. H01Q 19/12

(52) U.S. Cl. 343/840; 343/835

(57) ABSTRACT

A multibeam antenna for receiving and transmitting microwaves from satellites comprises a parabolic reflector (12) with parallelogram rim and a plurality of feed elements (13) which are located alongside one edge of the reflector (12) close to focus with minimum distance to the center of the reflector (12). The feed elements (13) are arranged along lines close to 45, 135, 225, 315 degree from main axes of parallelogram rim.

### OBJECT OF THE INVENTION

The present invention relates to a multibeam antenna including a reflector that is at least partially parabolic in one dimension. More particularly, but no exclusively, this invention relates to a multiple beam antenna system.

### STATE OF THE ART

It is known that the use antenna system for transmitting/receiving signals at the same frequency from more than one satellite. For instance, EP0670609B1 discloses a multibeam antenna that consisting of a parabolic reflector with square shape and radiating elements which are aligned on a line parallel to a diagonal of the square parabolic reflector.

Unfortunately, the antenna of this patent alone facilitates isolation between signals only on one of the diagonal of the parabolic reflector, and has drawbacks regarding cross polarisation and beam squint.

### CHARACTERISATION OF THE INVENTION

The technical problems mentioned above are resolved by the invention by constituting a multibeam antenna that includes a parabolic reflector with parallelogram (square or rectangular) perimeter, and a plurality of feed elements are located on lines parallel to one side of the perimeter of the parabolic reflector and close to middle of this side, in the focal plane.

Therefore, the distance between the feeds and the middle of the parabolic reflector is minimised.

Moreover this invention proposes to place the feeds in the focal plane and to arrange them in an hexagonal pattern in order to obtain improved isolation between beams at the same frequency.

In addition, it will improve cross polarisation performance with linear polarisation, and improve beam squint with circular polarisation.

### BRIEF DESCRIPTION OF THE DRAWINGS

A more detailed explanation of the invention is given in the following description based on the attached drawings in which:

FIG. 1 shows a perspective view of multibeam antenna according to an embodiment of the invention,

FIG. 2 shows a side elevation view of the multibeam antenna according to the invention,

FIG. 3 shows a front view of the multibeam antenna according to the invention, and

FIG. 4 show beams covering a target area according to the present invention.

### DESCRIPTION OF THE INVENTION

The antenna system of the present invention is used for communications between a satellite and the Earth, for example. The antenna system receives and/or transmits a single beam or group of beams as required for specific applications.

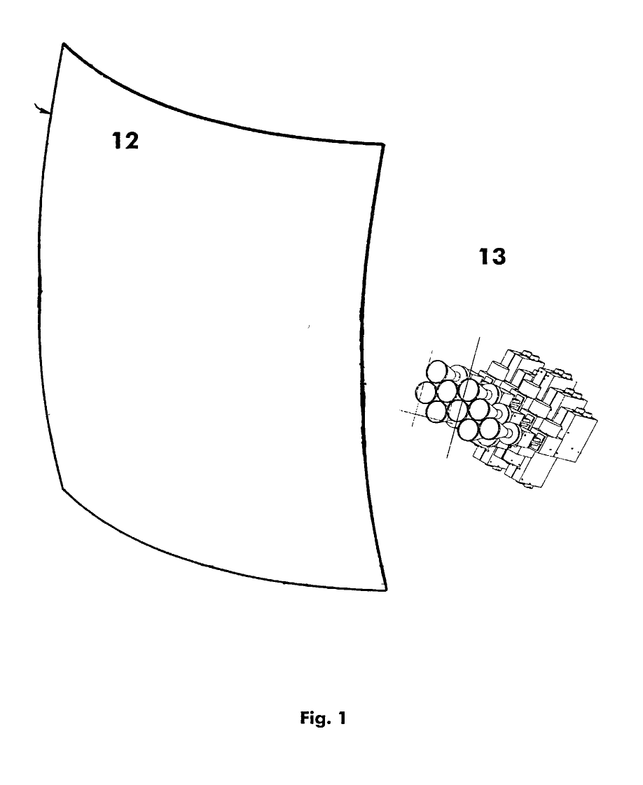

Referring to FIG. 1, a multibeam antenna embodying the present invention is shown. In this embodiment, the antenna system includes a reflector means 12 and a plurality of separate feeds 13 for radiating electromagnetic waves toward the reflector 12, which are arranged in a predetermined location and orientation.

The reflector 12 has a parabolic shape and parallelogram perimeter. This means that it is rectangular or square. The antenna system comprises separate feeds 13 with an offset geometry for the some parabolic reflector 12.

The plurality of feeds are collectively numbered 13 and may be combined in-groups, namely, clustering by frequency to provide antenna beams of the same frequency. Therefore, the feeds 13 of different frequency can be interleaved. The feeds 13 are aligned on a line parallel to one side of the perimeter of the parabolic reflector 12. In fact, they are placed around the middle of that side.

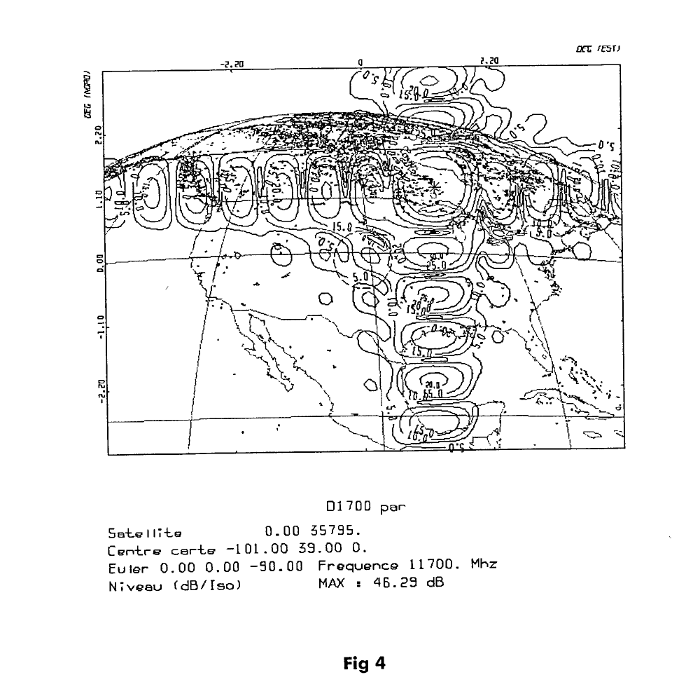

As shown in FIG. 4, the square reflector 12 forms an antenna beam in a preselected direction that impinges a predetermined coverage area on the Earth. Each antenna beam defines a separate coverage cell in the coverage area, wherein the position and orientation of the feeds 13 and parabolic reflector 12 provides antenna beams over full Earth field of view.

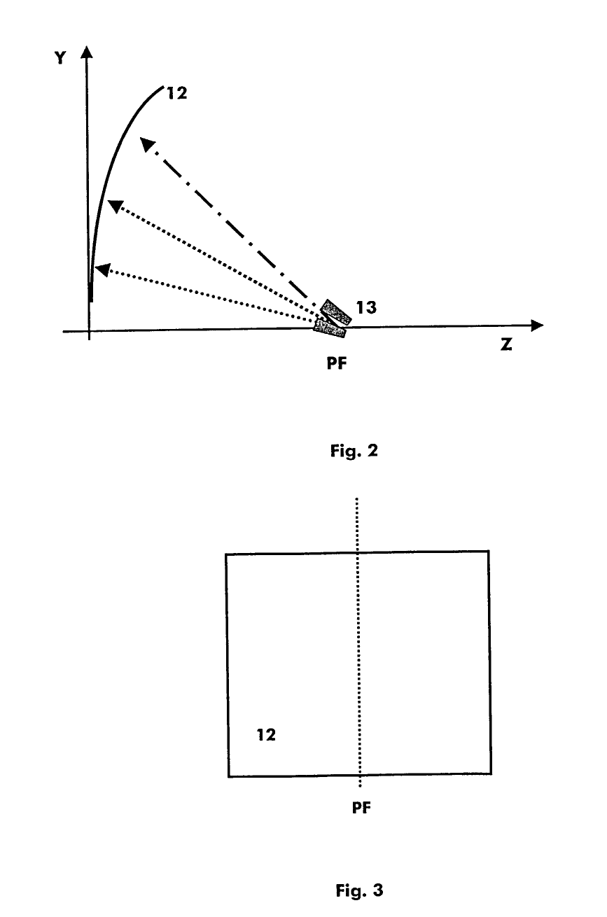

Referring now to FIG. 2, the parabolic reflector 12 is substantially inclined in the vertical plane by an angle of elevation. In particular, that inclination enables the feeds 13 to be offset in relation to the centre of the parabolic reflector 12. Such offset arrangement avoids the masking effect resulting from the intersection of the incident microwaves by the feeds 13.

Referring to FIG. 3, the focal plane is located at the middle of the parabolic reflector 12 and is parallel to two sides of the square perimeter. The feeds 13 are located at the level of the focal point PF of the parabolic reflector 12. Thus, minimising the distance between the feeds 13 and the middle of the parabolic reflector 12.

As a result, there is a large improvement in cross polarisation of linear polarisation signals compared to prior art. Another consequence is a large improvement (reduction) in beam squint for circular polarisation signals compared to prior art.

Referring again to FIG. 3, the feeds 13 can have any desirable configuration, such as circular, square, hexagonal and the like appropriate for a particular application. The signal intensity and phase of each feed signal is preselected to produce illumination beams having desirable beam characteristics.

In addition, the feeds 13 are substantially adjacent to one another and are distributed in an hexagonal pattern in the focal plane PF of the square reflector 12.

A radiation diagram of the antenna system is shown in FIG. 4, such that several antennas may be used, each providing some of the complete coverage. For example, 4 antennas may be used each provides one beam of the fourth beams (frequencies).

Since the beam signals must be isolated for most applications, all the beams do not use the same frequency. However frequency reuse is allowed for those beams which have good antenna pattern isolation. For example, a total of 4 frequencies may be used for the complete system.

The feeds 13 providing the same frequency are aligned along axes, which are at or close to 45, 135, 225, 315 degree from the main axes of the square. With this arrangement, the isolation is greatly improved compared to prior art.

Some feeds 13 which are remotely placed relative to the centre feed 13 may be placed on axes which are at or close to 0, 90, 180, 270 degree from the main axes of the square, because they are far from the other feeds 13, and benefit naturally from good isolation.

Referring again to FIG. 5, side lobes are arranged over two cross axes (star shape). The shape of main lobe is approaching a parallelogram. This means that its shape is approaching the shape of the reflector 12. Due to this fact the isolation between the main beam and the interference (other beam of the some frequency) is greatly improved in the case of the present invention. Typically the improvement will be 5 dB.

Therefore, the feeds 13 of the same frequency are located such that their main lobes are located out of side lobes.

The reflector rim may also have other polygonal shapes (n edges), though the best improvement in performance is obtained with rectangular or square shape in general.

1. Multibeam antenna including a parabolic reflector (12) with parallelogram rim, a plurality of feed elements (13); characterised in that the feed elements (13) are distributed in a polygonal pattern in the focal plane (PF) of the reflector (12) around main axes of said focal plane.

2. Multibeam antenna according to claim 1; characterised in that the feed elements (13) are adapted to be placed at the middle of one side of the perimeter of the parabolic reflector (12).

3. Multibeam antenna according to claim 2; characterised in that the feed elements (13) are adapted to arrange along lines at or closest to 45, 135, 225, 315 degrees from one of said main axes.

4. Satellite communications system for communicating with the Earth; characterised in that the multibeam antenna is adapted to be located onboard a communication satellite.
